(19) United States
(12) Patent Application Publication
(10) Pub. No.: US 2024/0310587 A1
(43) Pub. Date: Sep. 19, 2024

(54) MULTI-FIBER CONNECTOR APPARATUS

(71) Applicant: AFL IG LLC, Duncan, SC (US)

(72) Inventor: Keith Sullivan, Kent (GB)

(21) Appl. No.: 18/576,907

(22) PCT Filed: Jul. 6, 2022
(86) PCT No.: PCT/US2022/036217

§ 371 Date: Jan. 5, 2024

Related U.S. Application Data
(60) Provisional application No. 63/218,701, filed on Jul. 6, 2021.

(51) Int. Cl. G02B 6/40; G02B 6/38

(52) U.S. Cl. CPC G02B 6/406; G02B 6/3825

(57) ABSTRACT

A multi-fiber connector apparatus and fiber optic network are provided. The apparatus includes a housing surrounding a first multi-fiber connector and a second multi-fiber connector, the housing including at least two first multi-fiber connectors operably coupled to the second multi-fiber connector, the first multi-fiber connectors operably coupled to respective second multi-fiber connectors by a plurality of optical fibers within the housing. The first multi-fiber connector includes a first interface, the first interface including a first pin to pin distance of approximately 4.6 millimeters and a first total terminal spacing of approximately 2.75 millimeters. The second multi-fiber connector includes a second interface, the second interface including a second pin to pin distance of approximately 5.3 millimeters and a second total terminal spacing of approximately 3.75 millimeters.

### PRIORITY STATEMENT

The present application claims the benefit of priority to U.S. Provisional Patent Application Ser. No. 63/218,701, filed on Jul. 6, 2021, the disclosure of which is incorporated by reference herein in its entirety.

### FIELD

The present disclosure relates generally to fiber optic networks, and more specifically to apparatuses and methods for fiber optic connection.

### BACKGROUND

Current network speeds being deployed in data center environments have a maximum speed of 400 Giga bits per second (400 Gb). There is a desire to increase maximum network speeds beyond current maximum speeds. However, incorporating higher-speed structures and cabling can be limited at hardware interfaces. For instance, current structures are generally incapable to interface directly with various other structures, which may significantly inhibit increasing maximum network speed.

Accordingly, methods and apparatuses for increasing maximum fiber optic network speed are desired.

### BRIEF DESCRIPTION

Aspects and advantages of the cable support devices and assemblies in accordance with the present disclosure will be set forth in part in the following description, or may be obvious from the description, or may be learned through practice of the technology.

An aspect of the present disclosure is directed to a multi-fiber connector apparatus, the apparatus including a housing surrounding a first multi-fiber connector and a second multi-fiber connector, the housing including at least two first multi-fiber connectors operably coupled to the second multi-fiber connector, the first multi-fiber connectors operably coupled to respective second multi-fiber connectors by a plurality of optical fibers within the housing. The first multi-fiber connector includes a first interface, the first interface including a first pin to pin distance of approximately 4.6 millimeters and a first total terminal spacing of approximately 2.75 millimeters. The second multi-fiber connector includes a second interface, the second interface including a second pin to pin distance of approximately 5.3 millimeters and a second total terminal spacing of approximately 3.75 millimeters.

Another aspect of the present disclosure is directed to a fiber optic network. The fiber optic network includes a multi-fiber connector apparatus, the apparatus including a housing surrounding a first multi-fiber connector and a second multi-fiber connector, the first multi-fiber connector including a first key interface, and the second multi-fiber connector including a second key interface different from the first key interface, the housing including at least two first multi-fiber connectors operably coupled to the second multi-fiber connector, the first multi-fiber connectors operably coupled to respective second multi-fiber connectors by a plurality of optical fibers within the housing, wherein the first multi-fiber connector includes a first interface, the first interface including a first pin to pin distance and a first total terminal spacing, and wherein the second multi-fiber connector includes a second interface, the second interface including a second pin to pin distance different from the first pin to pin distance, and wherein the second interface includes a second total terminal spacing different from the first total terminal spacing; and a plurality of fiber array units each operably coupled to respective first multi-fiber connectors at respective first interfaces.

### BRIEF DESCRIPTION OF THE DRAWINGS

A full and enabling disclosure of the present cable support devices and assemblies, including the best mode of making and using the present systems and methods, directed to one of ordinary skill in the art, is set forth in the specification, which makes reference to the appended figures, in which:

FIG. 1 is a schematic illustration of a fiber optic communications network including an embodiment of a multi-fiber connector apparatus in accordance with aspects of the present disclosure;

FIG. 2 is a schematic illustration of a fiber optic communications network including an embodiment of a multi-fiber connector apparatus in accordance with aspects of the present disclosure;

FIG. 3 is a perspective view of an embodiment of a first interface at the multi-fiber connector apparatus in accordance with aspects of the present disclosure;

FIG. 4 is a view of an embodiment of a first interface at the multi-fiber connector apparatus in accordance with aspects of the present disclosure;

FIG. 5 is a perspective view of an embodiment of a second interface at the multi-fiber connector apparatus in accordance with aspects of the present disclosure;

FIG. 6 is a view of an embodiment of a second interface at the multi-fiber connector apparatus in accordance with aspects of the present disclosure;

FIG. 7 is a close-up schematic view of a portion of an embodiment of the multi-fiber connector apparatus in accordance with aspects of the present disclosure;

FIG. 8 is a perspective view of a first adapter of the apparatus in accordance with aspects of the present disclosure;

FIG. 9 is a close-up schematic view of a portion of an embodiment of the multi-fiber connector apparatus in accordance with aspects of the present disclosure;

FIG. 10 is a perspective view of a second adapter of the apparatus in accordance with aspects of the present disclosure; and

FIG. 11 is a schematic illustration of a fiber optic communications network including an embodiment of a multi-fiber connector apparatus in accordance with aspects of the present disclosure.

### DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value.

Embodiments of a fiber optic network and a multi-fiber connector apparatus are provided. Embodiments depicted and described herein allow data centers to utilize a 400 Giga bit (Gb) physical media dependency (PMD) with a sixteen-fiber or sixteen-way fiber multi-fiber connector. In particular, embodiments provided herein include a 400 Gb PMD having four pair of optical fibers (e.g., four lanes) each transmitting and receiving at a rate of 100 Gb. In total, the four pair of optical fibers result in eight optical fibers transmitting and receiving 400 Gb. The four pair of optical fibers are terminated to a twelve-fiber or twelve-way multi-fiber connector, such as a multi-fiber push-on (MPO) connector.

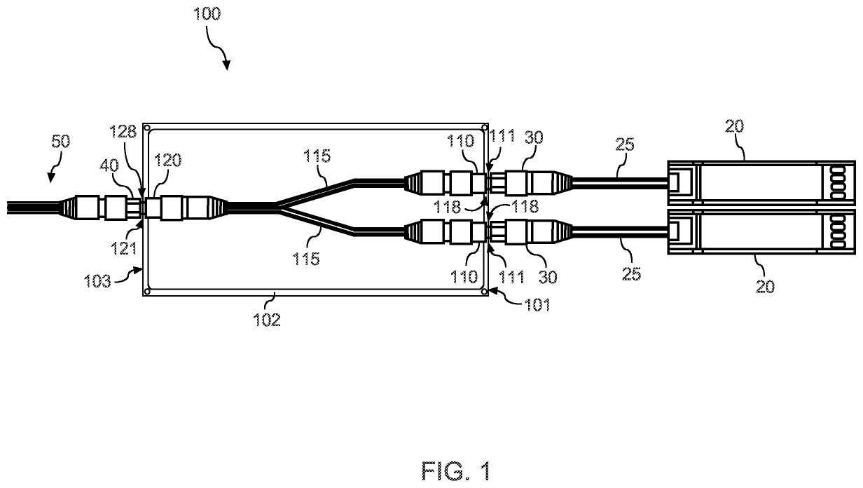

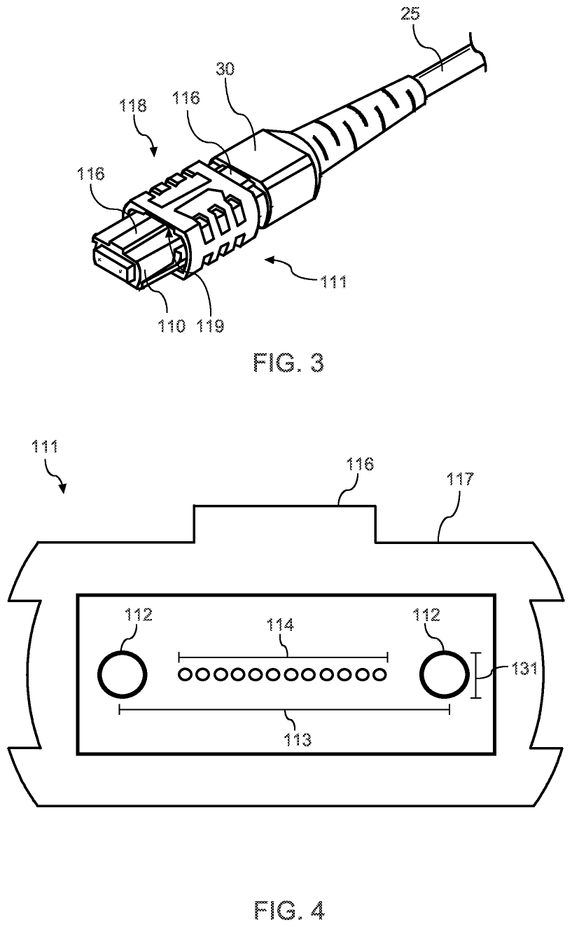

Referring to FIG. 1, a schematic embodiment of a fiber optic network 10 is provided. The network 10 includes a multi-fiber connector apparatus 100 operably coupling a physical media dependency (PMD) 20 to a fiber optic cable 50. As provided above, particular embodiments of the PMD 20 form a 400 Gb PMD having four pair of optical fibers 25. The four pair of optical fibers 25 are terminated to a multi-fiber connector 30. In particular embodiments, the multi-fiber connector 30 is a twelve-way multi-fiber connector. In certain embodiments, the connector 30 is a multi-fiber push-on connector, such as depicted in FIGS. 3-6. However, it should be appreciated that other embodiments may include any appropriate type of fiber optic connector, such as, but not limited to, an MMC connector, an SN-MT connector, an SC connector, an LC connector, an FC connector, an ST connector, an APC connector, or other type of multi-fiber connector, or combinations thereof.

A multi-fiber connector apparatus 100 includes a housing 102 surrounding a first multi-fiber connector 110 and a second multi-fiber connector 120. The housing 102 includes at least two first multi-fiber connectors 110 operably coupled to the second multi-fiber connector 120. In certain embodiments, the housing 102 includes factors of two or pairs of first multi-fiber connectors 110 operably coupled to each one of the second multi-fiber connector 120. The first multi-fiber connectors 110 are operably coupled to a respective second multi-fiber connector 120 by a plurality of optical fibers 115 within the housing 102. The first multi-fiber connector 110 includes a first interface 111. The second multi-fiber connector 120 includes a second interface 121 different from the first interface 111. It should be appreciated that each interface 111, 121 may generally include a male or pin-input portion and a female hole-receiving portion. The male and female portions are correspondingly spaced to one another to allow pins to insert into the holes or openings. Furthermore, each interface 111, 121 includes terminals configured to transmit and receive light, such as via the terminals spaced such as described at terminal spacing 114, 124 further herein.

In particular embodiments, housing 102 includes a first adapter 118 at first interface 111. As provided further herein, adapter 118 includes first interface 111 allowing connectors 30, 110 to operably couple. Additionally, housing 102 includes a second adapter 128 at second interface 121. As provided herein, adapter 128 includes second interface 121 different from the first interface 111 and allowing connectors 40, 120 to operably couple.

Referring to FIGS. 3-4, depictions of twelve-way multi-fiber connector interfaces in accordance with aspects of the present disclosure are provided. In particular, connectors 30, 110 include, e.g., sequentially numbered openings or holes one (1) through twelve (12). One or another of connectors 30, 110 include a first guide pin 112 configured to receive an opening at corresponding first adapter 118 at the first interface 111. The connectors 30, 110 at the first interface 111 include a first pin to pin distance 113 different from a second pin to pin distance 123 at the second interface 121. The first pin to pin distance 113 is approximately 4.6 millimeters. Connectors 30, 110 each include a first total terminal spacing 114. The first total terminal spacing 114 is a distance from an ordinally first to an ordinally last pin or corresponding opening at the pair of connectors connecting at the first interface 111. In particular embodiments, the first total terminal spacing 114 is a centerline-to-centerline distance between an ordinally first fiber or opening to an ordinally last fiber or opening. In a particular embodiment, the first total terminal spacing 114 is approximately 2.75 millimeters. In certain embodiments, connector 30 forms a male connector including guide pins 112 and connector 110 forms a female connector including correspondingly spaced openings configured to receive guide pins 112. However, in other embodiments, connector 110 forms a male connector including guide pins 112 and connector 30 forms a female connector including correspondingly spaced openings configured to receive guide pins 112.

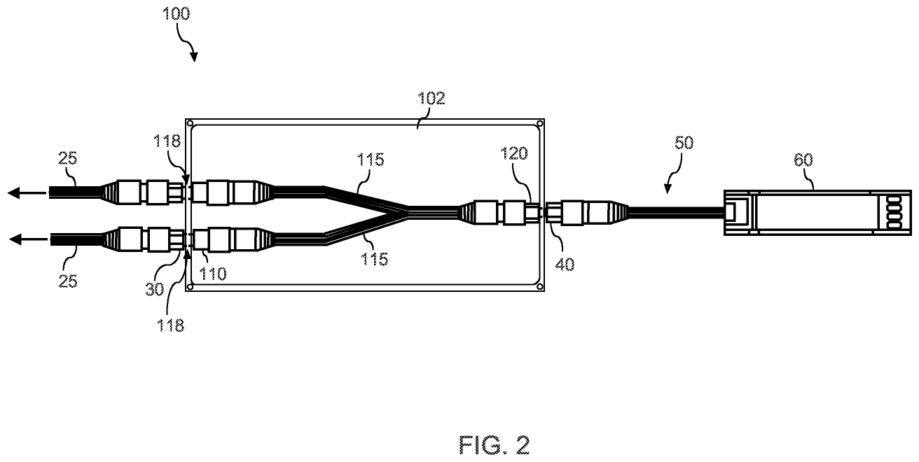

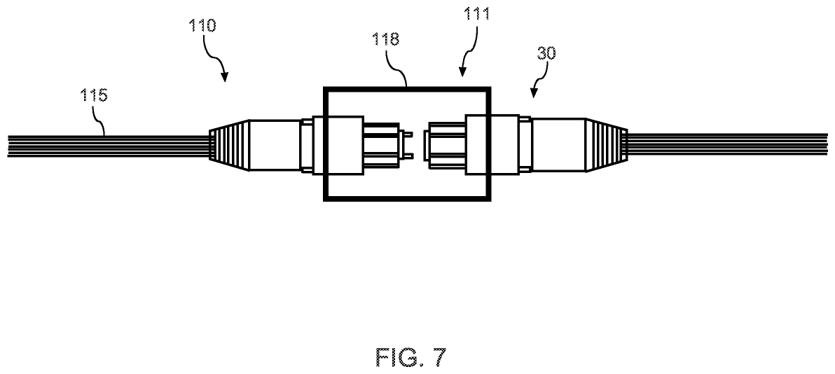

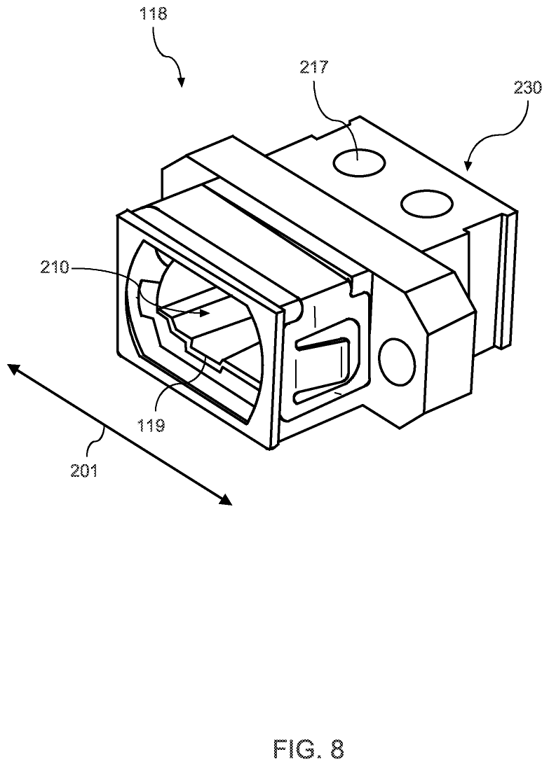

Referring still to FIGS. 3-4, connectors 30, 110 include a key 116. First adapter 118 positioned between connectors 30, 110 forms key opening 119 at which key 116 is receivable from both of connectors 30, 110. As depicted in FIG. 1-2, adapter 118 is positioned at housing 102 between connector 30 and connector 110. FIG. 7 depicts adapter 118 positioned between connector 110 (with fibers 115 and housing 102 removed for clarity) and connector 30.

In a particular embodiment, key 116 is positioned substantially center along an axis co-directional to the first total terminal spacing 114. In still particular embodiments, key 116 forms a raised material extending from a body 117 of each of connector 30, 110. In certain embodiments, each of connectors 30, 110 include key 116, such as a male interface. The first adapter 118 forms key opening 119, such as a female interface, corresponding to key 116. Key 116 may be located at a first surface (e.g., upper surface) at body 117 of connector 30, 110. Respective key opening 119 is formed at a corresponding surface at the adapter 118. In other embodiments, key 116 may alternatively be located at a second surface (e.g., lower surface) at body 117 at connector 30, 110 and respective key opening 119 at a corresponding surface at the adapter 118.

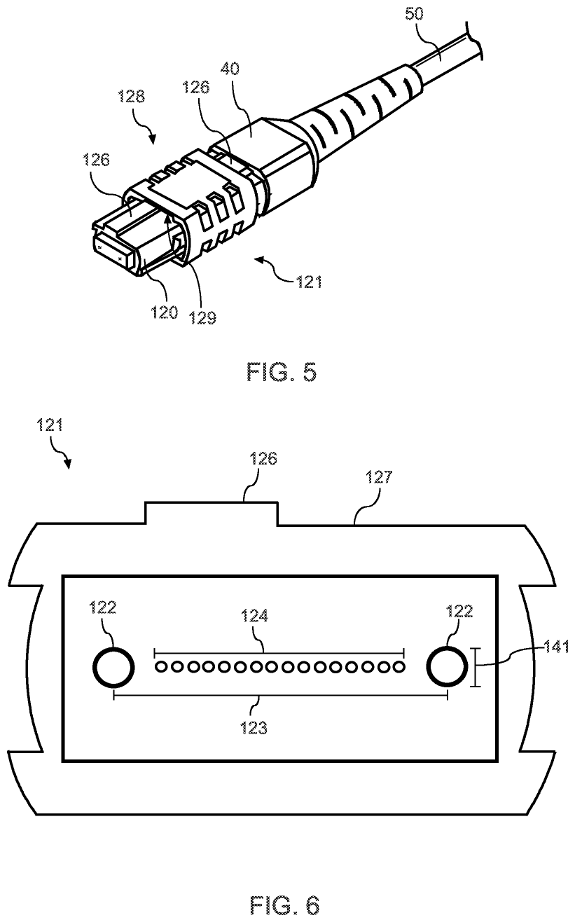

Referring to FIGS. 5-6, depictions of sixteen-way multi-fiber connector interfaces in accordance with aspects of the present disclosure are provided. In particular, connectors 40, 120 include, e.g., sequentially numbered holes one (1) through sixteen (16). One or another of connectors 40, 120 include a second guide pin 122 configured to receive an opening at corresponding second adapter 128 at the second interface 121. The connectors 40, 120 at the second interface 121 include a second pin to pin distance 123 different from the first pin to pin distance 113 at the first interface 111. The second pin to pin distance 123 is approximately 5.3 millimeters. Connectors 40, 120 each include a second total terminal spacing 124. The second total terminal spacing 124 is a distance from an ordinally first to an ordinally last pin or corresponding opening at the pair of connectors connecting at the second interface 121. In particular embodiments, the second total terminal spacing 124 is a centerline-to-centerline distance between an ordinally first fiber or opening to an ordinally last fiber or opening. In a particular embodiment, the second total terminal spacing is approximately 3.75 millimeters. In certain embodiments, connector 40 forms a male connector including guide pins 122 and connector 120 forms a female connector including correspondingly spaced openings configured to receive guide pins 122. However, in other embodiments, connector 120 forms a male connector including guide pins 122 and connector 40 forms a female connector including correspondingly spaced openings configured to receive guide pins 122.

In various embodiments, guide pin 112 includes a first guide pin diameter 131 different from guide pin 122 having a second guide pin diameter 141. In a particular embodiment first guide pin diameter 131 is approximately 0.70 millimeters and second guide pin diameter 141 is approximately 0.55 millimeters. However, it should be appreciated that other diameters of guide pin may be utilized at respective first and second interfaces 111, 121.

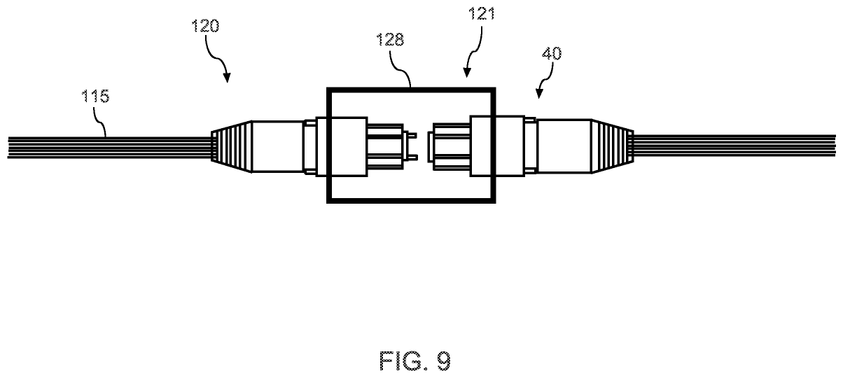

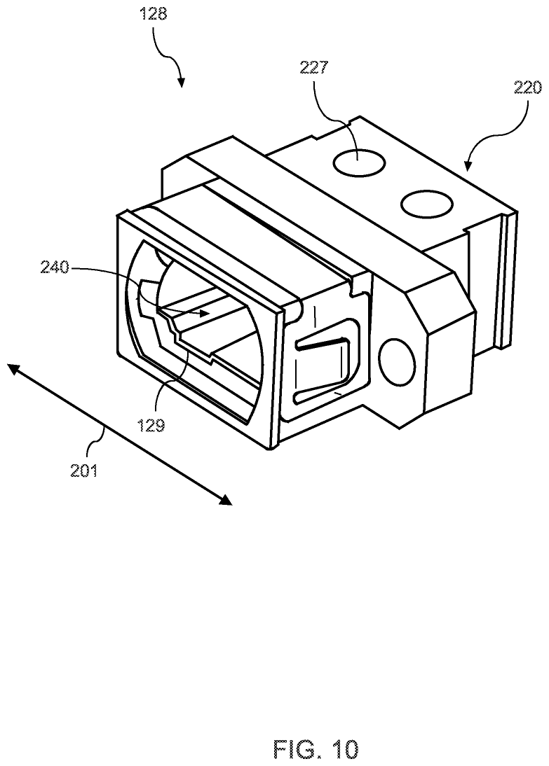

Referring still to FIGS. 5-6, connectors 40, 120 include a key 126. Second adapter 128 positioned between connectors 40, 120 forms a key opening 129 at which key 126 is receivable from both of connectors 40, 120. As depicted in FIGS. 1-2, adapter 128 is positioned at housing 102 between connector 40 and connector 120. FIG. 9 depicts adapter 128 positioned between connector 120 (with fibers 115 and housing 102 removed for clarity) and connector 40.

In a particular embodiment, key 126 is positioned off-center along an axis co-directional to the second total terminal spacing 124. In still particular embodiments, key 126 forms a raised material extending from a body 127 of each of connector 40, 120. The off-centered positioning of key 126 inhibits connection of a sixteen-way multi-fiber connector to a twelve-way port. In certain embodiments, each of connectors 40, 120 includes key 126, such as a male interface. The second adapter 128 forms key opening 129, such as a female interface, corresponding to key 126. In other embodiments, key 126 may alternatively be located at a second surface (e.g., lower surface) at body 127 at connector 40, 120. and respective key opening 129 at a corresponding surface at the adapter 128.

Referring now to FIG. 7, a close-up schematic view of first interface 111 at housing 102 (omitted for clarity) at which connectors 30, 110 operably couple to adapter 118 is provided. FIG. 8 provides a perspective view of an embodiment of first adapter 118. Adapter 118 includes a body 217 forming a first key opening 119 corresponding to first key 116. In particular embodiments, first key opening 119 is positioned substantially center along an axis 201 co-directional to the first total terminal spacing 114 (FIG. 5). Body 217 forms a first-end connector opening 230 corresponding to connector 30 and a second-end connector opening 210 corresponding to connector 110. Embodiments of adapter 118 allow for multi-fiber connector 30 forming a twelve-way multi-fiber connector to operably couple to first multi-fiber connector 110 within housing 102 (FIGS. 1-2). Optical fibers 115 within housing 102 are operably coupled to connector 110. Optical fibers 115 include four (4) receiver optical fibers and four (4) transmitter optical fibers terminated to connector 120 (FIGS. 1-2). In various embodiments, factors of eight (8) (e.g., 8, 16, 24, etc.) optical fibers extend from operable communication with connector 110 in operable communication with connector 30 to connector 120. In a particular embodiment, housing 102 consists of eight (8) optical fibers extending from operable communication with connector 110 in operable communication with connector 30 to connector 120.

Referring now to FIG. 9, a close-up schematic view of first interface 121 at housing 102 (omitted for clarity) at which connectors 40, 120 operably couple to adapter 128 is provided. FIG. 10 provides a perspective view of an embodiment of second adapter 128. Adapter 128 includes a body 227 forming a second key opening 129 corresponding to second key 126. In particular embodiments, second key opening 129 is positioned off-center along axis 201 co-directional to the second total terminal spacing 124 (FIG. 7). Body 227 forms a first-end connector opening 240 corresponding to connector 40 and a second-end connector opening 220 corresponding to connector 120. Embodiments of adapter 128 allow for multi-fiber connector 40 forming a sixteen-way multi-fiber connector to operably couple to second multi-fiber connector 120 within housing 102 (FIGS. 1-2). Optical fibers 115 within housing 102 are operably coupled to connector 120. Optical fibers 115 include factors of eight (8) receiver optical fibers and factors of eight (8) transmitter optical fibers terminated to connector 120 (FIGS. 1-2). In various embodiments, factors of eight (8) (e.g., 8, 16, 24, etc.) optical fibers extend from each connector 110 to connector 120. Accordingly, sixteen (16) optical fibers, including four (4) receiver optical fibers and four (4) transmitter optical fibers from each connector 110 is operably coupled to sixteen-way connector 120.

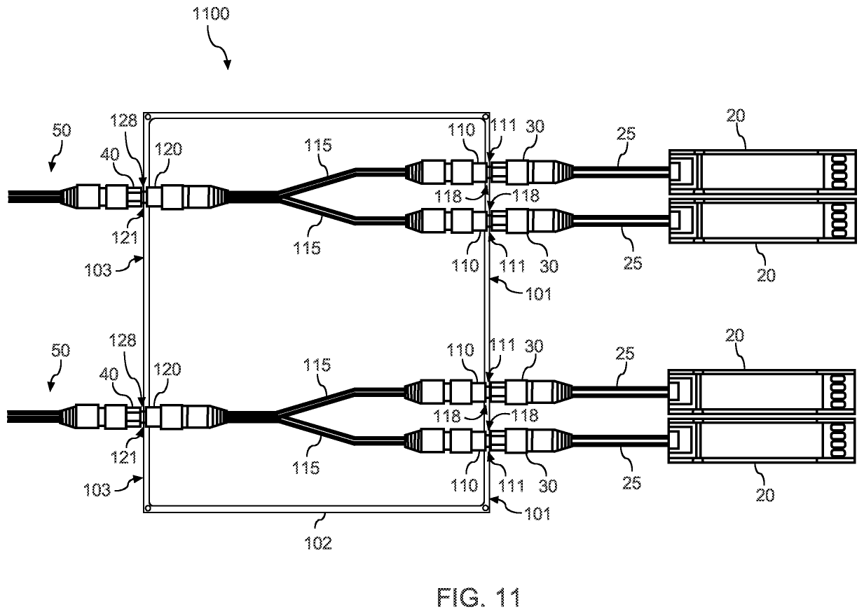

In still particular embodiments, pairs of connector 110 are in operable communication with respective ones of connector 120 within housing 102, such as depicted in an exemplary embodiment of apparatus 1100 in FIG. 11. Accordingly, a ratio of two (2) connectors 30, 110 may communicatively couple to one (1) connector 40, 120 at housing 102. Housing 102 may operably couple factors of sixteen (16) optical fibers from pairs of twelve-way factor multi-fiber connectors having factor-of-eight optical fibers.

Referring back to FIGS. 1-2, in a particular embodiment, housing 102 includes a first side 101 and a second side 103. First interface 111 is positioned at the first side 101 and second interface 121 is positioned at the second side 103. In certain embodiments, first side 101 is positioned distal to the second side 103

In a particular embodiment of the network 10 and a method for operation, the PMD 20 and optical fibers 25 includes one (1) or two (2) parallel transmission transceiver (e.g., 400G BASE-SR4 or 400G BASE-DR4) pigtail modules terminated at respective first interfaces 111 via respective connectors 30, 110. Respective twelve-way connectors 110, such as a pair of connectors 110, are terminated to sixteen-way connector 120 inside the housing 102.

In various embodiments, the first multi-fiber connector is a twelve-way factor multi-fiber connector and factor-of-eight optical fibers operably coupled to the twelve-way factor multi-fiber connector. In certain embodiments, the first multi-fiber connector may include twelve (12), twenty-four (24), thirty-six (36), etc. holes or openings. Additionally, the factor-of-eight optical fibers may include eight (8) fibers operably coupled at the twelve (12) openings, or sixteen (16) fibers operably coupled at the twenty-four (24) openings, or twenty-four (24) fibers operably coupled at the thirty-six (36) openings, etc.

In still further embodiments, the second multi-fiber connector is a sixteen-way factor multi-fiber connector including factors of sixteen (16) fibers operably coupled at respective openings. In certain embodiments, the second multi-fiber connector may include sixteen (16), thirty-two (32), sixty-four (64), etc. openings at which respective quantities of sixteen (16), thirty-two (32), sixty-four (64), etc. fibers are operably coupled.

In still particular embodiments, network 10 includes least two (2) PMDs forming fiber array units each forming a transceiver. The PMD 20 forming a transceiver includes the plurality of optical fibers 25 including four (4) receiver optical fibers and four (4) transmitter optical fibers. The plurality of optical fibers 25 is operably coupled to the twelve-way multi-fiber connector 30. The twelve-way multi-fiber connector 30 forming a fiber optic pigtail module is connectable to the multi-fiber connector apparatus 100 via first interface 111 at connector 110. Each connector 110 includes corresponding plurality of optical fibers 115 including four (4) receiver optical fibers and four (4) transmitter optical fibers terminated proximate to the first side 101 to connector 110 and terminated proximate to the second side 103 to connector 120. Accordingly, sixteen (16) optical fibers, including four (4) receiver optical fibers and four (4) transmitter optical fibers from each connector 110, is operably coupled to sixteen-way connector 120.

In one particular embodiment, a single PMD 20 includes eight (8) fibers from optical fibers 25 terminated to the PMD 20 and to holes three (3) through (6) and holes eleven (11) through fourteen (14) of connector 120 forming a BASE16 multi-fiber connector (MFC).

In another particular embodiment, network 10 includes a pair of PMD 20 each including eight (8) fibers from optical fibers 25 terminated to respective PMDs 20. A first PMD 20 terminates to holes one (1) through (4) and holes nine (9) through twelve (12) of connector 120 forming a BASE16 multi-fiber connector (MFC). A second PMD 20 terminates to holes five (5) through eight (8) and holes thirteen (13) through sixteen (16) of connector 120 forming the BASE16 MFC.

In further embodiments, network 10 includes a second PMD 60 different from the first PMD 20. In particular embodiments, PMD 60 is a parallel transmission transceiver, such as an 800G BASE-SR8 or 800G BASE-DR8 fiber array unit, configured to connect the sixteen-way connector 120.

Embodiments of the apparatus 100 and network provided herein allow for methods for transitioning from 400 Gb optical structures to 800 Gb, 1.6 Terabits per second (Tb), or 3.2 Tb optical structures. Accordingly, a datacenter operator may deploy a BASE16 structured cabling infrastructure while operating a 400 Gb structure. Methods and structures may further be implemented to replace the 400 Gb PMD with 800 Gb, 1.6 Tb, or 3.2 Tb PMDs. Additionally, combining two (2) PMDs 20 configured as 400G-BASE-DR4 modules to a single BASE16 multi-fiber connector allows for full density of the structured cabling system to be utilized.

Particular quantities, magnitudes, ranges, and combinations thereof provided herein provide advantages and benefits over known quantities, magnitudes, or ranges that may overlap in part or provided in part from known apparatuses. For instance, combinations of pin to pin distances, total terminal spacing, or fiber counts provided herein may allow for patentably significant and distinct improvements over known structures. In various instances, methods and structures provided herein may further be implemented to replace the 400 Gb PMD with structures and methods allowing for 2×, 4×, or 8× improvements in fiber optic network speed. Methods and structures provided herein may further be implemented to replace the 400 Gb PMD with 800 Gb, 1.6 Tb, or 3.2 Tb PMDs. Additionally, combining two (2) PMDs configured as 400G parallel transmission transceiver modules to a single BASE16 multi-fiber connector may allow for full density of the structured cabling system to be utilized, in contrast to known methods and structures that may be limited to, e.g., eight (8) fibers at twelve (12) fiber port structures.

Further aspects of the present subject matter are provided in one or more of the following clauses:

A multi-fiber connector apparatus, the apparatus including a housing surrounding a first multi-fiber connector and a second multi-fiber connector, the housing including at least two first multi-fiber connectors operably coupled to each one of the second multi-fiber connector, the first multi-fiber connectors operably coupled to respective second multi-fiber connectors by a plurality of optical fibers within the housing, wherein the first multi-fiber connector includes a first interface, the first interface including a first pin to pin distance of approximately 4.6 millimeters and a first total terminal spacing of approximately 2.75 millimeters, and wherein the second multi-fiber connector includes a second interface, the second interface including a second pin to pin distance of approximately 5.3 millimeters and a second total terminal spacing of approximately 3.75 millimeters.

The multi-fiber connector apparatus of any one or more clauses herein, wherein the first multi-fiber connector includes a twelve-way multi-fiber connector and eight optical fibers operably coupled to the twelve-way multi-fiber connector.

The multi-fiber connector apparatus of any one or more clauses herein, wherein the first multi-fiber connector includes a first key interface, and wherein the second multi-fiber connector includes a second key interface different from the first key interface.

The multi-fiber connector apparatus of any one or more clauses herein, wherein the second multi-fiber connector includes a sixteen-way multi-fiber connector.

The multi-fiber connector apparatus of any one or more clauses herein, wherein the eight optical fibers at each first multi-fiber connector are operably coupled within the housing to respective holes at the second-multi-fiber connector.

The multi-fiber connector apparatus of any one or more clauses herein, the housing forming a first side through which each first multi-fiber connector is partially extended, and the housing forming a second side through which each second multi-fiber connector is partially extended.

A fiber optic network, the fiber optic network including a multi-fiber connector apparatus, the apparatus including a housing surrounding a first multi-fiber connector and a second multi-fiber connector, the housing including at least two first multi-fiber connectors operably coupled to the second multi-fiber connector, the first multi-fiber connectors operably coupled to respective second multi-fiber connectors by a plurality of optical fibers within the housing, wherein the first multi-fiber connector includes a first interface, the first interface including a first pin to pin distance of approximately 4.6 millimeters and a first total terminal spacing of approximately 2.75 millimeters, and wherein the second multi-fiber connector includes a second interface, the second interface including a second pin to pin distance of approximately 5.3 millimeters and a second total terminal spacing of approximately 3.75 millimeters; and a plurality of fiber array units each operably coupled to respective first multi-fiber connectors at respective first interfaces.

The fiber optic network of any one or more clauses herein, wherein at least two of the fiber array units each include a transceiver having four receiver optical fibers and four transmitter optical fibers operably coupled to a twelve-way multi-fiber connector.

The fiber optic network of any one or more clauses herein, wherein the plurality of fiber array units is operably coupled to respective first multi-fiber connectors at the multi-fiber connector apparatus via a direct connection of a first twelve-way multi-fiber connector at the multi-fiber connector apparatus and a second twelve-way multi-fiber connector operably coupled to the four receiver optical fibers and four transmitter optical fibers at the fiber array unit.

The fiber optic network of any one or more clauses herein, wherein the second multi-fiber connector includes a sixteen-way multi-fiber connector.

The fiber optic network of any one or more clauses herein, wherein the eight optical fibers at each first multi-fiber connector are operably coupled within the housing to respective holes at the second-multi-fiber connector.

The fiber optic network of any one or more clauses herein, the network including a multi-fiber connector bundle including a mating interface corresponding to a direct connection to the second interface at the second multi-fiber connector at the multi-fiber connector apparatus.

The fiber optic network of any one or more clauses herein, wherein the first multi-fiber connector includes a twelve-way multi-fiber connector and eight optical fibers operably coupled to the twelve-way multi-fiber connector.

The fiber optic network of any one or more clauses herein, wherein the first multi-fiber connector includes a first key interface, and wherein the second multi-fiber connector includes a second key interface different from the first key interface.

The fiber optic network of any one or more clauses herein, wherein the second multi-fiber connector includes a sixteen-way multi-fiber connector.

The fiber optic network of any one or more clauses herein, wherein the eight optical fibers at each first multi-fiber connector are operably coupled within the housing to respective holes at the second-multi-fiber connector.

The fiber optic network of any one or more clauses herein, the housing forming a first side through which each first multi-fiber connector is partially extended, and the housing forming a second side through which each second multi-fiber connector is partially extended.

A method for operably connecting a 400G parallel transmission transceiver module to a BASE16 multi-fiber connector, the method including operably coupling four receiver optical fibers and four transmitter optical fibers to a 400G parallel transmission transceiver and a twelve-way multi-fiber connector; and operably coupling a pair of twelve-way multi-fiber connectors within a housing to a single sixteen-way multi-fiber connector.

A fiber optic network configured to perform the method of any one or more clauses herein.

A multi-fiber connector apparatus, the apparatus including a housing surrounding a first multi-fiber connector and a second multi-fiber connector, the housing including at least two first multi-fiber connectors operably coupled to the second multi-fiber connector, the first multi-fiber connectors operably coupled to respective second multi-fiber connectors by a plurality of optical fibers within the housing, wherein the first multi-fiber connector includes a first interface, the first interface including a first pin to pin distance of approximately 4.6 millimeters and a first total terminal spacing of approximately 2.75 millimeters, and wherein the second multi-fiber connector includes a second interface, the second interface including a second pin to pin distance of approximately 5.3 millimeters and a second total terminal spacing of approximately 3.75 millimeters.

The multi-fiber connector apparatus of any one or more clauses herein, wherein the first multi-fiber connector includes a twelve-way multi-fiber connector and eight optical fibers operably coupled to the twelve-way multi-fiber connector.

The multi-fiber connector apparatus of any one or more clauses herein, wherein the first multi-fiber connector includes a twelve-way factor multi-fiber connector and factor-of-eight optical fibers operably coupled to the twelve-way factor multi-fiber connector.

The multi-fiber connector apparatus of any one or more clauses herein, wherein the first multi-fiber connector includes a first key interface, and wherein the second multi-fiber connector includes a second key interface different from the first key interface.

The multi-fiber connector apparatus of any one or more clauses herein, wherein the second multi-fiber connector includes a sixteen-way factor multi-fiber connector.

The multi-fiber connector apparatus of any one or more clauses herein, wherein the sixteen-way factor multi-fiber connector includes any one or more pluralities of optical fibers.

The multi-fiber connector apparatus of any one or more clauses herein, wherein the second multi-fiber connector includes a sixteen-way multi-fiber connector.

The multi-fiber connector apparatus of any one or more clauses herein, wherein the eight optical fibers at each first multi-fiber connector are operably coupled within the housing to respective holes at the second-multi-fiber connector.

A fiber optic network, the fiber optic network including a multi-fiber connector apparatus, the apparatus including a housing surrounding a first multi-fiber connector and a second multi-fiber connector, the first multi-fiber connector including a first key interface, and the second multi-fiber connector including a second key interface different from the first key interface, the housing including at least two first multi-fiber connectors operably coupled to the second multi-fiber connector, the first multi-fiber connectors operably coupled to respective second multi-fiber connectors by a plurality of optical fibers within the housing, wherein the first multi-fiber connector includes a first interface, the first interface including a first pin to pin distance and a first total terminal spacing, and wherein the second multi-fiber connector includes a second interface, the second interface including a second pin to pin distance different from the first pin to pin distance, and wherein the second interface includes a second total terminal spacing different from the first total terminal spacing; and a plurality of fiber array units each operably coupled to respective first multi-fiber connectors at respective first interfaces.

The fiber optic network of any one or more clauses herein, wherein the first multi-fiber connector includes a twelve-way factor multi-fiber connector and factor-of-eight optical fibers operably coupled to the twelve-way factor multi-fiber connector.

The fiber optic network of any one or more clauses herein, wherein the second multi-fiber connector includes a sixteen-way factor multi-fiber connector.

The fiber optic network of any one or more clauses herein, wherein at least two of the fiber array units each include a transceiver having four receiver optical fibers and four transmitter optical fibers operably coupled to a twelve-way multi-fiber connector.

The fiber optic network of any one or more clauses herein, wherein the plurality of fiber array units is operably coupled to respective first multi-fiber connectors at the multi-fiber connector apparatus via a direct connection of a first twelve-way multi-fiber connector at the multi-fiber connector apparatus and a second twelve-way multi-fiber connector operably coupled to the four receiver optical fibers and four transmitter optical fibers at the fiber array unit.

The fiber optic network of any one or more clauses herein, wherein the second multi-fiber connector includes a sixteen-way factor multi-fiber connector.

The fiber optic network of any one or more clauses herein, wherein the second multi-fiber connector includes a sixteen-way multi-fiber connector.

The fiber optic network of any one or more clauses herein, wherein the eight optical fibers at each first multi-fiber connector are operably coupled within the housing to respective holes at the second-multi-fiber connector.

The fiber optic network of any one or more clauses herein, the network including a multi-fiber connector bundle including a mating interface corresponding to a direct connection to the second interface at the second multi-fiber connector at the multi-fiber connector apparatus.

The fiber optic network of any one or more clauses herein, wherein the first multi-fiber connector includes a twelve-way multi-fiber connector and eight optical fibers operably coupled to the twelve-way multi-fiber connector.

The fiber optic network of any one or more clauses herein, the first multi-fiber connector including a first pin to pin distance of approximately 4.6 millimeters and a first total terminal spacing of approximately 2.75 millimeters.

The fiber optic network of any one or more clauses herein, the second interface including a second pin to pin distance of approximately 5.3 millimeters and a second total terminal spacing of approximately 3.75 millimeters.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A multi-fiber connector apparatus, the apparatus comprising:
a housing surrounding a first multi-fiber connector and a second multi-fiber connector, the housing comprising at least two first multi-fiber connectors operably coupled to the second multi-fiber connector, the first multi-fiber connectors operably coupled to respective second multi-fiber connectors by a plurality of optical fibers within the housing,
wherein the first multi-fiber connector comprises a first interface, the first interface comprising a first pin to pin distance of approximately 4.6 millimeters and a first total terminal spacing of approximately 2.75 millimeters, and
wherein the second multi-fiber connector comprises a second interface, the second interface comprising a second pin to pin distance of approximately 5.3 millimeters and a second total terminal spacing of approximately 3.75 millimeters.

2. The multi-fiber connector apparatus of claim 1, wherein the first multi-fiber connector comprises a twelve-way multi-fiber connector and eight optical fibers operably coupled to the twelve-way multi-fiber connector.

3. The multi-fiber connector apparatus of claim 1, wherein the first multi-fiber connector comprises a twelve-way factor multi-fiber connector and factor-of-eight optical fibers operably coupled to the twelve-way factor multi-fiber connector.

4. The multi-fiber connector apparatus of claim 3, wherein the first multi-fiber connector comprises a first key interface, and wherein the second multi-fiber connector comprises a second key interface different from the first key interface.

5. The multi-fiber connector apparatus of claim 4, wherein the second multi-fiber connector comprises a sixteen-way factor multi-fiber connector.

6. The multi-fiber connector apparatus of claim 4, wherein the sixteen-way factor multi-fiber connector comprises any one or more pluralities of optical fibers.

7. The multi-fiber connector apparatus of claim 4, wherein the second multi-fiber connector comprises a sixteen-way multi-fiber connector.

8. The multi-fiber connector apparatus of claim 4, wherein the eight optical fibers at each first multi-fiber connector are operably coupled within the housing to respective holes at the second-multi-fiber connector.

9. A fiber optic network, the fiber optic network comprising:
a multi-fiber connector apparatus, the apparatus comprising a housing surrounding a first multi-fiber connector and a second multi-fiber connector, the first multi-fiber connector comprising a first key interface, and the second multi-fiber connector comprising a second key interface different from the first key interface, the housing comprising at least two first multi-fiber connectors operably coupled to the second multi-fiber connector, the first multi-fiber connectors operably coupled to respective second multi-fiber connectors by a plurality of optical fibers within the housing, wherein the first multi-fiber connector comprises a first interface, the first interface comprising a first pin to pin distance and a first total terminal spacing, and wherein the second multi-fiber connector comprises a second interface, the second interface comprising a second pin to pin distance different from the first pin to pin distance, and wherein the second interface comprises a second total terminal spacing different from the first total terminal spacing; and
a plurality of fiber array units each operably coupled to respective first multi-fiber connectors at respective first interfaces.

10. The fiber optic network of claim 9, wherein the first multi-fiber connector comprises a twelve-way factor multi-fiber connector and factor-of-eight optical fibers operably coupled to the twelve-way factor multi-fiber connector.

11. The fiber optic network of claim 10, wherein the second multi-fiber connector comprises a sixteen-way factor multi-fiber connector.

12. The fiber optic network of claim 9, wherein at least two of the fiber array units each comprise a transceiver having four receiver optical fibers and four transmitter optical fibers operably coupled to a twelve-way multi-fiber connector.

13. The fiber optic network of claim 9, wherein the plurality of fiber array units is operably coupled to respective first multi-fiber connectors at the multi-fiber connector apparatus via a direct connection of a first twelve-way multi-fiber connector at the multi-fiber connector apparatus and a second twelve-way multi-fiber connector operably coupled to the four receiver optical fibers and four transmitter optical fibers at the fiber array unit.

14. The fiber optic network of claim 13, wherein the second multi-fiber connector comprises a sixteen-way factor multi-fiber connector.

15. The fiber optic network of claim 14, wherein the second multi-fiber connector comprises a sixteen-way multi-fiber connector.

16. The fiber optic network of claim 15, wherein the eight optical fibers at each first multi-fiber connector are operably coupled within the housing to respective holes at the second-multi-fiber connector.

17. The fiber optic network of claim 9, the network comprising:
a multi-fiber connector bundle comprising a mating interface corresponding to a direct connection to the second interface at the second multi-fiber connector at the multi-fiber connector apparatus.

18. The fiber optic network of claim 9, wherein the first multi-fiber connector comprises a twelve-way multi-fiber connector and eight optical fibers operably coupled to the twelve-way multi-fiber connector.

19. The fiber optic network of claim 9, the first multi-fiber connector comprising a first pin to pin distance of approximately 4.6 millimeters and a first total terminal spacing of approximately 2.75 millimeters.

20. The fiber optic network of claim 19, the second interface comprising a second pin to pin distance of approximately 5.3 millimeters and a second total terminal spacing of approximately 3.75 millimeters.
